(19) United States
(12) Patent Application Publication
(10) Pub. No.: US 2023/0243015 A1
(43) Pub. Date: Aug. 3, 2023

(54) METHOD FOR PROCESSING CORROSION RESISTANT AUSTENITIC STAINLESS STEEL

(71) Applicant: SINTOKOGIO, LTD., Nagoya-shi (JP)

(72) Inventors: Yuta SAITO, Nagoya-shi (JP); Yuji KOBAYASHI, Nagoya-shi (JP)

(73) Assignee: SINTOKOGIO, LTD., Nagoya-shi (JP)

(21) Appl. No.: 18/098,226

(22) Filed: Jan. 18, 2023

(30) Foreign Application Priority Data
Feb. 1, 2022 (JP) 2022-014026

(51) Int. Cl. C21D 10/00; C21D 7/04

(52) U.S. Cl. CPC C21D 10/005; C21D 7/04; C21D 2211/001; C21D 2241/01

(57) ABSTRACT

A method for processing corrosion resistant austenitic stainless steel includes: preparing a workpiece made of austenitic stainless steel; and applying compressive residual stress to a surface layer of the workpiece without subjecting the surface layer to plastic working.

### TECHNICAL FIELD

The present disclosure relates to a method for processing corrosion-resistant austenitic stainless steel. This application is based upon and claims the benefit of priority from Japanese Patent Application No. 2022-014026, filed on Feb. 1, 2022, the entire contents of which are incorporated herein by reference.

### BACKGROUND

As a method for improving corrosion resistance of austenitic stainless steel, a method for applying compressive residual stress by shot peening or burnishing is known. In shot peening or burnishing, deformation induced martensite transformation is generated by collision of media or pushing of a tool, and an austenite phase is transformed into a martensite phase having poor corrosion resistance. Therefore, the corrosion resistance is relatively lowered.

Japanese Patent Application Laid-Open No. 1978-104520 (Patent Literature 1) discloses a method in which the surface of an austenitic stainless steel is plastically worked to generate compressive residual stress at least on the surface. In this method, plastic working is performed at a temperature higher than the upper limit temperature at which strain induced martensitic transformation occurs. As a result, compressive residual stress can be applied to the surface without generating the martensite phase.

### SUMMARY

In the above method, since plastic working is performed at the high temperature, sufficient compressive residual stress cannot be applied.

Accordingly, a purpose of the present disclosure is to provide a method for processing a corrosion-resistant austenitic stainless steel capable of applying sufficient compressive residual stress.

A method for processing a corrosion-resistant austenitic stainless steel according to one aspect of the present disclosure includes the following steps (1) and (2).

Preparing a workpiece made of austenitic stainless steel.

Applying compressive residual stress to the surface layer of the workpiece without subjecting the surface layer to plastic working.

In the processing accompanied by plastic working such as shot peening and burnishing, large compressive residual stress is applied, but deformation induced martensite transformation generates. In the method for processing a corrosion-resistant austenitic stainless steel according to one aspect of the present disclosure, the surface layer of the workpiece is not subjected to plastic working. Therefore, compressive residual stress can be applied without generating deformation induced martensite transformation in the surface layer of the workpiece. Since the martensite phase having poor corrosion resistance is suppressed, sufficient compressive residual stress can be applied while maintaining corrosion resistance.

The applying may be performed using a shock wave generated by at least one of laser ablation and cavitation. In this case, the plastic deformation due to the shock wave causes plastic strain inside the crystal grains, but does not cause deformation or refinement of the crystal grains because it is not plastic working. Therefore, sufficient compressive residual stress can be applied while maintaining corrosion resistance.

The applying may include generating the laser ablation by setting a power density of laser light to 1 GW/cm² or more and 20 GW/cm² or less. In this case, by setting the power density to 1 GW/cm² or more, laser ablation can be reliably generated. By setting the power density to 20 GW/cm² or less, surface damage of the workpiece is suppressed.

The applying may include generating the laser ablation by setting a pulse width of laser light to 150 fsec or more and 30 nsec or less. In this case, the laser ablation can be reliably generated.

The applying may be performed while the workpiece is cooled. In this case, since an increase in the temperature of the workpiece is suppressed, a decrease in the applied compressive residual stress is suppressed.

The applying may be performed while the workpiece is disposed in a liquid. In this case, the workpiece can be easily cooled.

The applying may be performed in such a way that a change amount of a martensite phase in the surface layer is ±10% or less. In this case, since the amount of change in the martensite phase having poor corrosion resistance is suppressed, the corrosion resistance can be maintained.

The compressive residual stress applied in the applying may be 500 MPa or more. In this case, sufficient compressive residual stress can be applied.

The applying may include applying the compressive residual stress to the surface layer without removing the surface layer.

The applying may be performed in such a way as to plastically deform the workpiece without changing a crystal state of the workpiece. In this case, induced martensite transformation does not generate, and compressive residual stress can be applied while the material structure remains in the austenite phase.

The applying may include generating the laser ablation by setting a pulse width of laser light to 150 fsec or more and less than 10 psec. In this case, laser ablation can be more reliably generated.

### BRIEF DESCRIPTION OF THE DRAWINGS

FIG. 1 is a configuration diagram showing a laser irradiation device.

FIG. 2 is a configuration diagram showing an air cavitation device.

FIG. 3 is a configuration diagram showing a submerged cavitation device.

FIG. 4 is an SEM image obtained by a field emission scanning electron microscope (FE-SEM).

FIG. 5 is a phase map obtained from an analysis result based on an electron backscatter diffraction (EBSD) method.

FIG. 6 is a graph showing a residual stress distribution.

### DETAILED DESCRIPTION

Hereinafter, embodiments will be described in detail with reference to the accompanying drawings. In the description of the drawings, the same or corresponding elements are denoted by the same reference numerals, and redundant description is omitted.

A method for processing a corrosion-resistant austenitic stainless steel according to an embodiment is a method for producing a corrosion-resistant austenitic stainless steel to which compressive residual stress is applied by applying the compressive residual stress to a surface layer of an austenitic stainless steel without subjecting the surface layer to plastic working. The processing method according to the embodiment includes a preparation step and a residual stress application step.

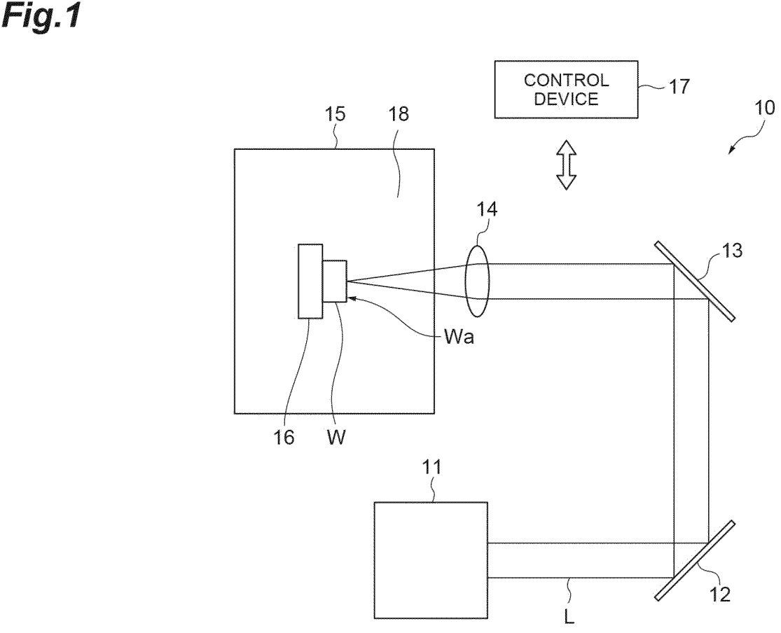

The preparation step is a step of preparing a workpiece W (see FIG. 1) made of austenitic stainless steel. The austenitic stainless steel used as the workpiece W is, for example, SUS304 (JIS standard). SUS304 is a relatively inexpensive steel material among austenitic stainless steels.

The residual stress application step is a step of applying compressive residual stress to the surface layer Wa (see FIG. 1) of the workpiece W without subjecting the surface layer Wa to plastic working and removing the surface layer Wa. Here, the surface layer Wa is a region having a depth of, for example, 100 µm or less from the surface of the workpiece W. The plastic working is a working that causes deformation or refinement of crystal grains. The residual stress application step is performed so that the change amount of the martensite phase in the surface layer Wa is ±10% or less. The compressive residual stress applied to the surface layer Wa in the residual stress application step is 500 MPa or more and may be 550 MPa or more.

The residual stress application step is performed by using a shock wave generated by at least one of laser ablation and cavitation. The laser peening and cavitation peening are methods for applying compressive residual stress to the inside of a metal material in the same manner as shot peening and burnishing. In shot peening and burnishing, media and tools are brought into physical contact with a surface of the metal material surface, whereas in the laser peening and cavitation peening there is no such physical contact.

In the laser peening and the cavitation peening, it is possible to plastically deform the workpiece W without changing the crystal state of the workpiece W by using the shock wave. Since the plastic deformation caused by the shock wave is not plastic working, deformation or refinement of crystal grains does not occur. The plastic deformation caused by the shock wave generates plastic strain inside the crystal grains. Therefore, the compressive residual stress can be applied while the material structure is kept in the austenite phase without causing induced martensite transformation.

The residual stress application step is performed while the workpiece W is cooled. Examples of the cooling method include water cooling and air cooling. Cooling may be performed using a liquid other than water and a gas other than air. The residual stress application step is performed, for example, while the workpiece W is disposed in a liquid. The residual stress application step is performed, for example, at room temperature.

FIG. 1 is a configuration diagram showing a laser irradiation device used in the residual stress application step. As shown in FIG. 1, the laser irradiation device 10 includes a laser oscillator 11, reflection mirrors 12 and 13, a condensing lens 14, a water tank 15, a holder 16, and a control device 17. The laser oscillator 11 is a device that oscillates laser light L. The reflection mirrors 12 and 13 transmits the laser light L oscillated by the laser oscillator 11 to the condensing lens 14. The condensing lens 14 condenses the laser light L at a processing position of the workpiece W with high density. The water tank 15 is filled with a transparent liquid 18 such as water. The holder 16 holds the workpiece W and arranges the workpiece W in the water tank 15. The holder 16 is an actuator or a robot.

The laser irradiation device 10 is controlled by the control device 17. The control device 17 is configured as a motion controller such as a programmable logic controller (PLC) or a digital signal processor (DSP), for example. The control device 17 may be configured as a computer system including a processor such as a central processing unit (CPU), memories such as a random access memory (RAM) and a read only memory (ROM), input/output devices such as a touch panel, a mouse, a keyboard, and a display, and a communication device such as a network card. The control device 17 operates each hardware under the control of the processor to realize the function of the control device 17. The control of the processor is based on the computer program stored in the memory.

When the residual stress application step is performed using the laser irradiation device 10, first, the workpiece W is placed on the holder 16. Next, the workpiece W is moved into the water tank 15 and placed in the liquid 18 by the holder 16. Next, while the workpiece W is cooled by the liquid 18, the workpiece W is irradiated with the laser light L. The laser light L is a short-pulse laser light. The pulse width of the laser light L is 150 fsec or more and 30 nsec or less. The pulse width of the laser light L may be 4 nsec or more and 10 nsec or less. The pulse width of the laser light L may 150 fsec or more and less than 10 psec.

The laser light L is oscillated by the laser oscillator 11 and then transmitted to the condenser lens 14 by the optical system including the reflection mirrors 12 and 13. The laser light L is condensed at high density by the condensing lens 14 and applied to the surface of the workpiece W via the liquid 18. The power density of the laser light L is set to 1 GW/cm² or more and 20 GW/cm² or less. The power density of the laser light L may be set to 3 GW/cm² or more and 15 GW/cm² or less.

In the surface layer Wa of the workpiece W corresponding to the irradiation point of the laser light L, the peening effect by the laser peening is generated as follows. First, when the laser light L is irradiated on the surface of the workpiece W, laser ablation occurs on the surface of the workpiece W and plasma is generated. In the atmosphere, the material of the irradiation point is vaporized. Since the irradiation point on the workpiece W is covered with the liquid 18, expansion of the plasma is suppressed. As a result, the plasma has a high pressure, and a shock wave is generated by the pressure of the plasma. By the propagation of the shock wave, a plastic deformation region is generated inside the workpiece W. In the plastic deformation region, compressive residual stress occurs due to restraint from an undeformed portion. As described above, since the plastic deformation caused by the shock wave is not plastic working, deformation or refinement of the crystal grains does not occur.

The irradiation of the laser light L corresponds to the operation of the holder 16, and is performed while shifting the irradiation point on the workpiece W. Each time the workpiece W is irradiated with the laser light L, the holder 16 moves the workpiece W to move the irradiation point on the workpiece W. Thus, an area of the workpiece W irradiated with the laser light L can be secured.

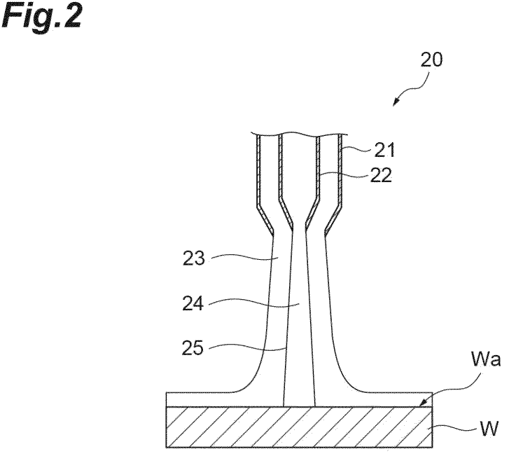

FIG. 2 is a configuration diagram showing an air cavitation device used in the residual stress application step. As shown in FIG. 2, the air cavitation machine 20 includes a first nozzle 21, a second nozzle 22, and a control device (not shown). The second nozzle 22 has a diameter smaller than that of the first nozzle 21 and is disposed inside the first nozzle 21. The first nozzle 21 and the second nozzle 22 are disposed on the workpiece W such that the nozzle tips thereof face the surface of the workpiece W. The control device controls the air cavitation device 20. The control device has, for example, the same configuration as the control device 17 of the laser irradiation device 10.

The first nozzle 21 sprays a liquid 23 such as water onto the surface of the workpiece W at a low speed. The second nozzle 22 sprays a liquid 24 such as water onto the surface of the workpiece W at high speed. Cavitation bubbles are generated at the tip of the second nozzle 22. The cavitation bubbles grow on the shear layer 25 between the low-speed jet of the liquid 23 and the high-speed jet of the liquid 24. By spraying the cavitation jet flow accompanied by such bubbles onto the surface of the workpiece W, a shock wave generated at the time of collapse of the cavitation bubbles is transmitted to the workpiece W. As a result, a peening effect occurs on the surface layer Wa of the workpiece W. That is, the crystal structure undergoes high-density dislocation, and compressive residual stress is imparted. In the cavitation peening, the generation, growth, and collapse of bubbles greatly affect the peening effect. The rear surface of the workpiece W to which the liquid 23 and liquid 24 is not sprayed may be air-cooled.

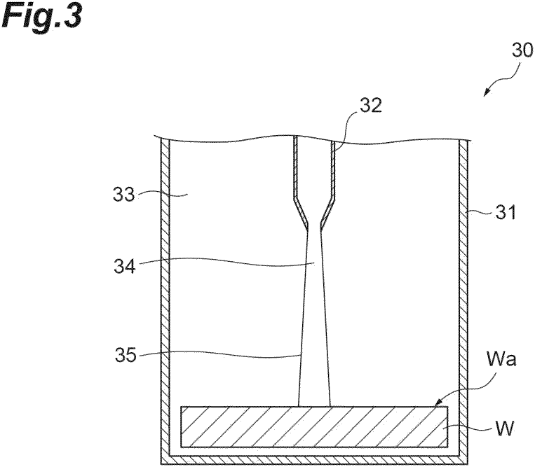

FIG. 3 is a configuration diagram showing a submerged cavitation device used in the residual stress application step. As shown in FIG. 3, the submerged cavitation device 30 includes a water tank 31, a nozzle 32, and a control device (not shown). The water tank 31 is filled with a liquid 33 such as water. A workpiece W is disposed inside the water tank 31. The tip of the nozzle 32 is disposed in the water tank 31 and faces the surface of the workpiece W. The control device controls the submerged cavitation device 30. The control device has, for example, the same configuration as the control device 17 of the laser irradiation device 10.

The nozzle 32 sprays a liquid 34 such as water onto the surface of the workpiece W at high speed. Cavitation bubbles are generated at the tip of the nozzle 32. The cavitation bubbles grow on the shear layer 35 between the high-speed jet of liquid 34 and liquid 33. By spraying the cavitation jet flow accompanied by such bubbles onto the surface of the workpiece W, a shock wave generated at the time of collapse of the cavitation bubbles is transmitted to the workpiece W. As a result, a peening effect occurs on the surface layer Wa of the workpiece W.

As described above, in the processing method according to the embodiment, the surface layer Wa of the workpiece W is not subjected to plastic working. Therefore, the compressive residual stress can be applied without generating deformation induced martensite transformation in the surface layer Wa of the workpiece W. Since the martensite phase having poor corrosion resistance is suppressed, sufficient compressive residual stress can be applied while maintaining corrosion resistance.

When steel is used in a hydrogen-exposed region, hydrogen enters the steel and hydrogen-embrittlement occurs. In the martensite phase, the dislocation density is high and hydrogen-embrittlement is likely to occur. In the austenite phase, the dislocation density is small, and hydrogen-embrittlement hardly occurs. For example, SUS304 is processed as a workpiece W by the processing method according to the embodiment, and residual stress is applied without degrading hydrogen-embrittlement. Thus, a steel material having corrosion resistance equivalent to SUS316 (JIS standard) can be obtained.

As described above, in the processing method disclosed in Patent Literature 1, it is necessary to perform processing at a temperature higher than the upper limit temperature at which strain-induced martensitic transformation occurs. Therefore, in addition to the problem that sufficient compressive residual stress cannot be applied, there is a problem that it takes time to heat or residual stress varies due to uneven heating. On the other hand, since the residual stress application step according to the present embodiment is performed at normal temperature, the above described problem can be solved.

The residual stress application step is performed by using the shock wave generated by at least one of the laser ablation and cavitation. Although the plastic deformation due to the shock wave causes plastic strain inside the crystal grains, since the plastic deformation is not plastic working, deformation or refinement of the crystal grains does not occur. Therefore, it is possible to apply sufficient compressive residual stress to the surface layer Wa of the workpiece W while maintaining corrosion resistance.

In the residual stress application step, laser ablation is generated by setting the power density of the laser light L to 1 GW/cm² or more and 20 GW/cm² or less. By setting the power density to 1 GW/cm² or more, laser ablation can be reliably generated. By setting the power density to 20 GW/cm² or less, surface damage of the workpiece W is suppressed. The power density of the laser light L may 3 GW/cm² or more and 15 GW/cm² or less. By setting the power density to 3 GW/cm² or more, laser ablation can be more reliably generated. By setting the power density to 15 GW/cm² or less, surface damage of the workpiece W is further suppressed.

In the residual stress application step, laser ablation is generated by setting the pulse width of the laser light L to 150 fsec or more and 30 nsec or less. Thus, the laser ablation can be reliably generated. The pulse width of the laser light L may be 4 nsec or more and 10 nsec or less. Thus, the laser ablation can be more reliably generated.

The residual stress application step is performed while the workpiece W is cooled. The residual stress application step using the laser irradiation device 10 is performed while the workpiece W is cooled by the liquid 18. The residual stress application step using the air cavitation device 20 is performed while the workpiece W is cooled by at least the liquid 23 and liquid 24. The residual stress application step using the submerged cavitation device 30 is performed while the workpiece W is cooled by the liquid 33 and liquid 34. Therefore, the temperature rise of the workpiece W is suppressed. As the temperature of the workpiece W is higher, the applied compressive residual stress is lower. Since the temperature rise of the workpiece W is suppressed, the reduction of the applied compressive residual stress is suppressed.

The residual stress application step using the laser irradiation device 10 is performed while the workpiece W is disposed in the liquid 18. The residual stress application step using the submerged cavitation device 30 is performed while the workpiece W is disposed in the liquid 33. Thus, the workpiece W can be easily cooled.

The residual stress application step is performed so that the change amount of the martensite phase in the surface layer Wa is ±10% or less. Since the change amount of the martensite phase inferior in corrosion resistance is suppressed as described above, the corrosion resistance of the workpiece W can be maintained.

The compressive residual stress applied by the residual stress application step is 500 MPa or more. Thus, a sufficient compressive residual stress can be applied to the workpiece W.

The present invention is not necessarily limited to the above-described embodiment, and various modifications can be made without departing from the scope of the present invention.

Examples will be described below.

As an example, a sample to which compressive residual stress was imparted by laser peening was produced. To be specific, first, a sample made of SUS304 was prepared as a workpiece, and was placed in a water tank filled with water. Laser peening was performed by using a laser irradiation device with a spot size of 0.7 mm, a power density of 4.2 GW/cm², a pulse energy of 100 mJ, and an irradiation density of 0.3 pulses/mm².

As a comparative example, a sample to which compressive residual stress was imparted by shot peening instead of laser peening was produced. The shot peening was performed by using media (RCW06PM) composed of amorphous round metallic spheres, with an injection pressure of 0.2 MPa, an injection amount of 9.0 kg/min, a coverage of 300% or more, and an arc height of 0.361 mmA.

### Measurement of Retained Austenite Volume Amount

In order to verify the occurrence of induced martensite transformation, the volume amount of retained austenite in the surface layer of each of the sample according to the example, the sample according to the comparative example, and the sample in an untreated state was measured. The measurement was performed by a cos α method using a residual stress-measuring device µ-X360 manufactured by Pulstec Industrial Co., Ltd. A Cr bulb was used, with an irradiation radius of φ 1.0 mm, a collimator radius of φ 1.0 mm, and a measurement angle of 0 degree. The measurement results are shown in Table 1.

TABLE 1

| | Untreated | Comparative Example | Example |
|---|---|---|---|
| Retained Austenite Volume Amount (vol%) | 95.9 | 56.5 | 96.7 |

As shown in Table 1, in the comparative example after the shot peening, about 40% of the induced martensite transformation occurred compared to the untreated state. On the other hand, in the examples after laser peening, induced martensite transformation did not occur as compared to the untreated state. The slight increase in austenite volume in the examples over that in the untreated state is believed to be due to measurement error.

### Tissue Observation

In order to visually verify the occurrence of induced martensite transformation, the structure of the sample according to the example was observed by a field emission scanning electron microscope (FE-SEM). To be specific, the sample was cut, and the surfaces and cross sections thereof were observed using a Schottky field emission scanning electron microscope JSM-7200F manufactured by JEOL Ltd.

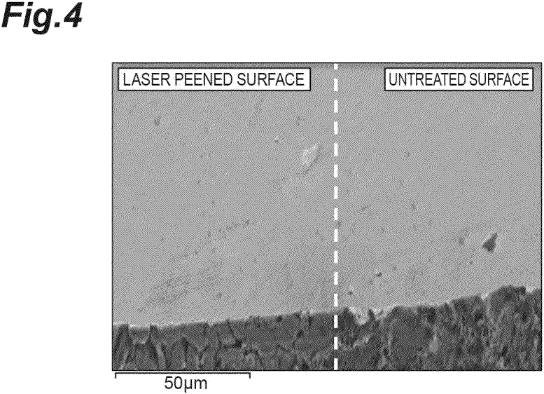

FIG. 4 is an SEM image obtained by FE-SEM. On the left side of the dotted line in FIG. 4, a laser peened surface and a cross section of a tissue under the laser peened surface are shown. On the right side of the dotted line in FIG. 4, an untreated surface and a cross section of the tissue below the untreated surface are shown. As shown in FIG. 4, it can be confirmed that there is no difference between the laser-peened portion and the untreated portion in the SEM image.

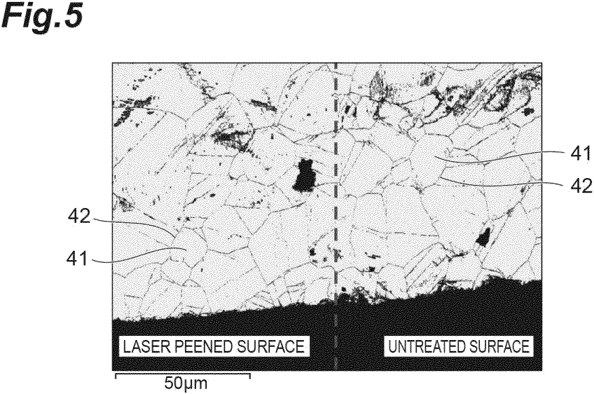

FIG. 5 is a phase map obtained from an analysis result based on the EBSD method. In FIG. 5, the FCC structure is shown in light color, and cementite, the BCC structure, and chromium carbide are shown in dark color. Here, the FCC structure is an austenite phase, and the BCC structure is a martensite phase. As shown in FIG. 5, a large part of the analysis range is occupied by the austenite phase in both the laser-peened portion and the untreated portion. As a result, it is understood that the induced martensite transformation does not occur even when the laser peening is performed. In addition, it can be confirmed that there is no difference in the size of the crystal grains 41 and the state of the crystal grain boundaries 42 indicated by black lines between the laser-peened portion and the untreated portion.

### Residual Stress Measurement

The residual stress of the sample surface layer was measured for the sample according to the example. The measurement was performed by a cos α method using a residual stress-measuring device µ-X360 manufactured by Pulstec Industrial Co., Ltd. A Cr bulb was used, the irradiation radius was φ 1.0 mm, the collimator radius was φ 1.0 mm, and the measurement angle was 35 degrees.

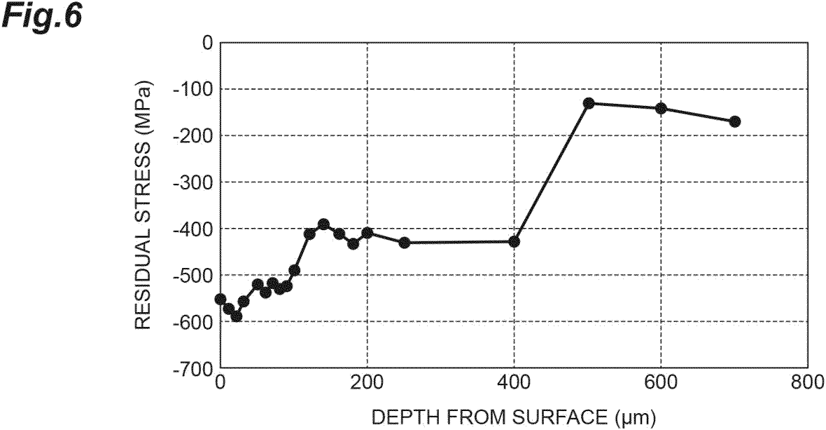

FIG. 6 is a graph showing the residual stress distribution. In FIG. 6, the horizontal axis represents the depth (µ m) from the surface, and the vertical axis represents the residual stress (MPa). The compression side is shown as a negative value and the tension side is shown as a positive value. As shown in FIG. 6, a residual stress of -550 MPa or less, that is, a compressive residual stress of 550 MPa or more, is generated in the vicinity of the surfaces. This value is larger than the residual stress applied by the processing method described in Patent Literature 1 by a 100 MPa or more on the compression side. It is considered that this value strongly acts on the stress-corrosion cracking and can suppress new generation of the stress-corrosion cracking.

1. A method for processing corrosion resistant austenitic stainless steel, the method comprising:
preparing a workpiece made of austenitic stainless steel; and
applying compressive residual stress to a surface layer of the workpiece without subjecting the surface layer to plastic working.

2. The method according to claim 1, wherein the applying is performed using a shock wave generated by at least one of laser ablation and cavitation.

3. The method according to claim 2, wherein the applying includes generating the laser ablation by setting a power density of laser light to 1 GW/cm² or more and 20 GW/cm² or less.

4. The method according to claim 2, wherein the applying includes generating the laser ablation by setting a pulse width of laser light to 150 fsec or more and 30 nsec or less.

5. The method according to claim 1, wherein the applying is performed while the workpiece is cooled.

6. The method according to claim 1, wherein the applying is performed while the workpiece is disposed in a liquid.

7. The method according to claim 1, wherein the applying is performed in such a way that a change amount of a martensite phase in the surface layer is ±10% or less.

8. The method according to claim 1, wherein the compressive residual stress applied in the applying is 500 MPa or more.

9. The method according to claim 1, wherein the applying includes applying the compressive residual stress to the surface layer without removing the surface layer.

10. The method according to claim 1, wherein the applying is performed in such a way as to plastically deform the workpiece without changing a crystal state of the workpiece.

11. The method according to claim 2, wherein the applying includes generating the laser ablation by setting a pulse width of laser light to 150 fsec or more and less than 10 psec.
